(19) United States
(12) Patent Application Publication
(10) Pub. No.: US 2022/0304129 A1
(43) Pub. Date: Sep. 22, 2022

(54) MULTIMODE CONTROL SYSTEM

(71) Applicant: B-K Lighting, Inc., Madera, CA (US)

(72) Inventor: Mark Hansston, Madera, CA (US)

(21) Appl. No.: 17/665,393

(22) Filed: Feb. 4, 2022

Related U.S. Application Data
(63) Continuation of application No. 63/145,810, filed on Feb. 4, 2021.

(51) Int. Cl. H05B 47/19; H05B 47/185

(52) U.S. Cl. CPC H05B 47/19; H05B 47/185

(57) ABSTRACT

Dual mode lighting fixture control systems are disclosed that can comprising a wireless device capable of generating control commands and wirelessly transmitting the control commands. A control unit is included that is arranged to receive the control commands and generate wireless fixture control signals and powerline light fixture control signals. A plurality of first light fixtures are included wherein at least some of the first light fixtures are arranged to receive the wireless fixture control signals. A plurality of second light fixtures are coupled to and arranged to receive control signals from a first powerline, wherein the control unit transmits the powerline light fixture control signals on the first powerline to said second light fixtures. In some embodiments, the wireless device can comprise a laptop computer or a cell phone.

This application claims the benefit of U.S. Provisional Patent Appl. Ser. No. 63/145,810, filed on Feb. 4, 2021.

### BACKGROUND OF THE INVENTION

### Field of the Invention

This invention relates to multimode and/or multiband communication to control electrical devices or fixtures, and particularly to control the emission characteristics of lighting fixtures.

### Description of the Related Art

Controlling the operation of electrical devices can be challenging, particularly for controlling outdoor architectural or landscape lighting fixtures. Many outdoor lighting fixtures are buried underground with light emitting out a lens or opening at surface level. For hard wired lighting fixtures, this can require burying of conductors through the outside area to carry an electrical signal for a power source or controller, to the lighting fixtures.

More recently, there has been continued development and adoption of systems and components communicating using the “internet of things”. Traditional wireless radio frequency (RF) control using internet of things (IOT) typically transmits at relatively high frequencies, such as 2.4 GHz. Communication at these frequencies can present challenges in certain applications such as light fixtures arranged underground or in building where RF barriers can be present, such as walls, soil, metal objects, etc. Frequencies such as 2.4 GHz are very poor at penetrating these barriers. Furthermore, some lighting fixtures may also use metal for their housings and other components, which can present a further barrier to communication at these IOT frequencies. Furthermore, there may be instances where multiple devices are communicating at this frequency and communication with lighting fixtures can result in a “clutter” of communication.

Communication at lower frequencies, such as 915 MHz (commonly referred to as 900 MHz) can at least partially solve the 2.4 Ghz clutter issue, and this frequency offers somewhat better performance at penetrating barriers (e.g. walls, metal, soil, etc.) compared to higher IOT frequencies.

Line of sight control relies on wirelessly transmitting signals directly to a device, such as a lighting fixture, when there is nothing obstructing the signal path. Communications can take place at different frequencies when there is a clear view or line of sight between the control unit and the light fixture. However, light fixtures that are buried under the ground still pose a significant connectivity problem. IOT frequencies have poor penetration of ground and the metal components of the light fixture. The 900 MHz wireless signal has improved penetration, but it is typically not adequate for efficient control of the lighting fixtures. In these cases, a different method may be needed to communicate between fixtures, such as including an additional set of wires between the control unit and the fixtures. Often times, due to the location of the fixtures, this approach is not possible, and in instances where it is possible, this approach may be cost prohibitive.

There are a number of commercial powerline communication (PLC) systems that use the main power lines to transmit data between power sources and controller, and devices and fixtures. Powerline communication transmits by injecting communication signals onto household or commercial building wiring and/or the electrical power lines. Powerline communication can be used for computer networks, wired smart meters and other purposes. There are many types of PLC systems, operating at a wide variety of frequencies.

Powerline communication can be used to penetrate or bypass barriers that would otherwise block IOT frequencies. These systems, however, tend to be expensive, may limit use of the powerline to the circuit to which it is connected, and do not integrate easily with existing lighting fixtures.

### SUMMARY OF THE INVENTION

The present invention is generally directed to multi-mode communication systems for communicating with electric or electronic devices. Systems according to the present invention can comprise a light fixture emission control system that allows for lower frequency powerline communication and also for wireless line of sight communication. This allows for the control unit to communicate by the best means possible. For fixtures with a relatively clear line of sight, traditional line of sight wireless communications can be used. Where there are barriers between the control unit and the fixtures, the system can rely on lower frequency powerline communication to bypass the barriers.

In some embodiments, the control unit can comprise a bidirectional dual band radio transceiver, with one mode for line of sight transmission and the other for lower frequency powerline transmission. Light fixtures connected for communication on the main powerlines typically needs to be in relatively close proximity to powerlines. In some embodiments, this can comprise fixtures close enough such that they can be wired to the main powerlines. Devices that are not connected to the power line can also be using the line-of-sight wireless communication mode. Some of these line-of-sight devices can be solar powered or battery powered devices as well.

The systems according to the present invention can comprise many different features as described below. These and other aspects and advantages of the invention will become apparent from the following detailed description and the accompanying drawings which illustrate by way of example the features of the invention.

### BRIEF DESCRIPTION OF THE DRAWINGS

FIG. 1 is a block diagram showing one embodiment of multiple mode control system according to the present invention; and

FIG. 2 is a block diagram showing another embodiment of multiple mode control system according to the present invention.

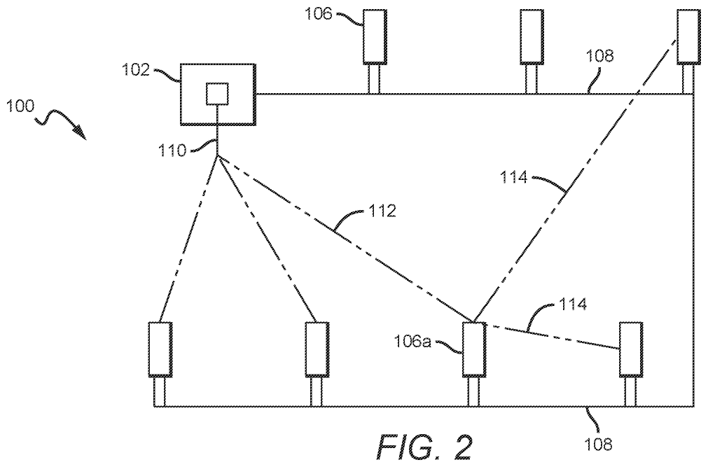

### DETAILED DESCRIPTION OF THE INVENTION

The present invention is directed to control systems that rely on multiple modes of communication for the control of the electrical devices and fixtures. Some embodiments of the present invention are directed to controlling the emission of lighting fixtures with embodiments of the control systems operating in different communications modes depending on the most advantageous communication mode for the particular devices or fixtures.

In some embodiments, one of the modes can be primarily wireless communication in applications where this communication is practical and efficient. This is particularly applicable to fixtures having a clear line of sight with the controller. For fixtures where wireless communication would be blocked or attenuated by barriers, the system can rely primarily on other communication methods, such as over a building main powerline. Some embodiments of this communication mode can comprise one of many types of PLC systems, operating at different frequencies.

In some embodiments, the fixtures can have features that allows for communication in the different modes to be bidirectional, which can allow the fixtures to send information to the control unit, with some examples being health reports, sensor data. These features can also allow for communication between fixtures in the overall lighting system. This can increase the effectiveness and performance of the system, and extend communication to places a traditional RF solution would not be able to reach. Additionally, the simplicity and compact nature of the invention allows for more compact systems and devices in comparison to prior methods of powerline communication. In some embodiments, the systems according to the present invention can offer bidirectional line of sight communications and powerline communication where appropriate for the particular fixture.

Control units according to the present invention can be operated under user control using different means, such as by a hard-wired controls to a control unit. In other embodiments the control unit can be controlled wirelessly, such as by a wireless control link between the control unit and a computer or cellphone. In other embodiments, the control unit can be preprogrammed to give the desired lighting control, with the program capable of operating without user input. In each of these modes of operation, the control units can then generate the appropriate signals to the light fixtures so that the fixtures emit in a manner as desired by the user. The control unit can communicate with the light fixtures using many different communication protocols such as Digital Addressable Lighting Interface (DALI) or DMX512.

The present invention is described herein with reference to certain embodiments, but it is understood that the invention can be embodied in many different forms and should not be construed as limited to the embodiments set forth herein. It is further understood that different embodiments can comprise different features, elements and components arranged in different ways.

It will be understood that when an element is referred to as being “on” or “connected to” or “coupled to” another element, it can be directly on, in contact or coupled to the other element or intervening elements may be present. In contrast, when an element is referred to as being “directly on”, or “directly connected to” or “directly coupled to” another element, there are no intervening elements present.

Although the terms first, second, etc. may be used herein to describe various elements, and/or sections, these elements and/or sections should not be limited by these terms. These terms are only used to distinguish one element, or section from another element, or section. Thus, a first element or section discussed herein could be termed a second element, or section without departing from the teachings of the present invention.

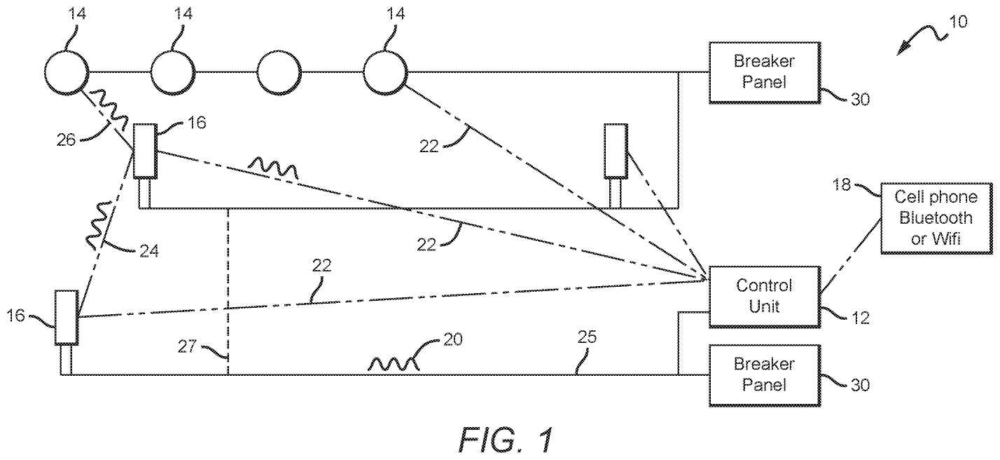

FIG. 1 shows one embodiment of a multi-mode control system 10 according to the present invention. The system 10 comprises a control unit 12 that generates the necessary signals to control both underground light fixtures 14 and above ground light fixtures 16. It is understood that underground light fixtures 14 can include fixtures that are fully or partially underground, and can mean fixtures fully or partially embedded in different materials such as gravel or concrete. Above ground fixtures can mean fixtures that are mounted above the soil, such as by stakes. These can also include fixture mounted to a structure or tree, or can include above ground pathway or stairway fixtures. These are only some of the many fixtures that can be used in systems according to the present invention, and it is understood that other fixtures can be used.

The control unit 12 can be operated by a user using many different arrangements and mechanisms as described above. In some embodiments, manual controls can be provided directly on or hardwired to the control unit 12, or the controls can be wirelessly communicated to the control unit 12, that can be manipulated by the user to control operation of the control unit. These manual controls can comprise many different mechanisms, including but not limited to knobs, dials, pushbuttons, touchscreens, etc.

In other embodiments, the control unit can be wirelessly controlled, with some embodiments using known wireless protocols such a Bluetooth or WIFI. In some embodiments, the control unit 12 can be controlled locally or remotely by computer, such as by a personal computer.

In the embodiment shown, the control unit 12 is controlled by a cellphone 18 that is operated by the user (such as through a cellphone application) to communicate with the control unit 12 by Bluetooth or WIFI communication link. In the embodiment shown, the cellphone 18 communicates with the control unit 12 using a 2.4 GHz frequency signal, with the control unit 12 having a receiver to accept the signal. It is understood that the control unit can use many other frequencies, and it is understood that these frequencies can change as cell phone technology advances. The control unit 12 can also have a transmitter to transmit signals to the cell phone 18. These signals can include status and operating signals regarding the lighting fixtures 14, 16 and/or the control unit 12. The control unit can alternatively be controlled by using a wireless modem that can communicate with a cell phone tower (e.g. Verizon or AT&T network) and not directly to a cell phone.

Based on the communications or instructions received from the user, the control unit can generate the signals to operate the lighting fixtures with the desired characteristics. These can include, but are not limited to, on/off, emission color, emission intensity, emission color temperature, etc.

The control unit 12 can be operated to generate multiple bands of communication frequencies that can be transmitted to the light fixtures in different ways, all of which can be used to control emission of the light fixtures 14, 16. In the embodiment shown, the control unit can generate first control signal 20 that can be transmitted on one or more main powerlines 25, such as those found in a residence or commercial building. The first signal can be relatively low frequency, with some embodiments having a first signal frequency of less that 100 MHz. In some of these embodiments, the first RF signal can be in the range of 0 to 50 MHz, with some embodiments having a signal with a frequency of approximately 27 MHz.

The above are only some examples of the frequencies that can be used in different embodiments of the present invention. It is also understood that other frequencies can be used such as those in the Industrial, Scientific and Medical (ISM) frequency bands. For example, some embodiments can utilize frequencies in the 40.66 to 40.70 MHz frequency band with some utilizing a frequency of approximately 40.68 MHz.

It is noted that a coupling wire or conductor 27 can be included between powerlines within the same building or between powerlines in different buildings or circuits that are close enough proximity to make such connection practical. This can allow for the lower frequency first control signal 22 to be conducted between the different powerlines without having to couple the powerlines to separate or second control unit 12.

The control unit 12 can also be operated to generate a second higher frequency control signal 22 that can be used to send wireless communication/control signals directly to the fixtures 14, 16. The second control signal 22 is particularly adapted for use with the ones of the fixtures 14, 16 having a clear line of sight with the control unit 12, or where any barriers between the particular ones of the fixtures 14, 16 do not overly attenuate the signal 22. The control signal 22 can have many different frequencies, with some embodiments having a 900 MHz frequency.

Fixtures 14, 16 can also have transmitters and receivers arranged to allow for wireless communication between the fixtures. This is particularly applicable to the above ground fixtures 16, but can also be used with the underground fixture where close enough and not too attenuated. In the embodiment shown, the third fixture-to-fixture communication/control signal 24 is shown as being transmitted between different ones of the above ground fixtures 16. This allows for the control unit 12 to communicate directly with one of the above ground fixtures 16 in a clear line of sight or over the power line 25. This signal can then be relayed from the fixtures 16 receiving the signal directly from the control unit 12, to others of the fixtures 16 in a clear line of sight. This allows for the signal 22 to be relayed to ones of the fixtures 16 that are not in clear line of sight with the control unit 12. In other embodiments, this relaying can also be used to extend the transmission range of the control unit 12. The third control signal 24 can have many different frequencies, and in the embodiment shown has substantially the same frequency as signal 22. The signal 24 can have many different frequencies, with some embodiments having a 900 MHz frequency.

The fixtures 16 can similarly be arranged to provide a fourth fixture-to-fixture control signal 26 transmitted between different ones of the above ground fixtures 16, and one or more of the below ground fixtures 14. This allows for the control unit 12 to communicate directly with one of the above ground fixtures 16. This signal can then be relayed from the fixture 16 receiving the signal directly from the control unit 12, and to the below ground fixtures 14 in a clearer line of sight with the fixture 16. This allows for the signal 22 to be relayed to ones of the underground fixtures 14 not in a clear line of sight with the control unit 12. Like above, this relaying can also be used to extend the transmission range of the control unit 12. The fourth control signal 26 can have many different frequencies and in the embodiment shown has substantially the same frequency as signal 22. The signal 26 can have many different frequencies, with some embodiments having a 900 MHz frequency.

Each of the fixtures and powerlines can be coupled to a breaker panel 30 that are commercially available and generally understood in the industry.

The systems according to the present invention provide improved performance and flexibility in controlling the emission of lighting fixtures. The fixtures can be arranged to respond to wireless signals 22 directly from the control unit 12, or lower frequency signals 20 on the main powerline from the control unit, or both. This provides an enhanced system for controlling lighting fixtures that may be out of the line of sight with the control unit, while eliminating the need to install additional hard wiring between the control unit 12 and fixtures 14, 16.

It is understood that the multi-mode control systems 100 according to the present invention can be used in many different systems and in many different ways beyond those shown above. FIG. shows another embodiment of a multi-mode control system according to the present invention that includes control unit 102 and light fixtures 106. In the embodiment shown, the light fixtures 106 are above ground, but it is understood that they can be any of the light fixtures described above, including below ground light fixtures.

The control system 100 is arranged so that the fixtures 106 operate at low voltage, with the embodiment shown driving the control unit 102 driving the light fixtures with low voltage power. Low voltage light fixture operation is generally understood in the lighting industry, with the embodiment shown having light fixtures operating from 12 VAC power. In the embodiment shown, the control unit 102 accepts power from the main power line and converts it to low voltage 12 VAC. This low voltage power is then delivered to the light fixtures 106 along low voltage wire 108, which can be buried. Each of light fixtures 106 can then be coupled to the wire 108 to receive the low voltage power. In the embodiment shown, the main light fixture control can be included in the same control unit 102 or same location as the transformer. The control unit 102 can then insert the control signals after the transformer, and control signals can be transmitted to the light fixtures 106 from the control unit 102 along the wires 108.

The control unit 102 can also comprise a multi-mode radio 110 to transmit wireless rf control signals 112 to all or some of the light fixtures 106. All or some of the fixtures 106 can have an rf receiver and/or ab rf transmitter. By way of example, fixture 106a can have a receiver to receive wireless control signals 112 from the radio 110, and can also have a transmitter to transmit fixture to fixture control signals 114 to others of the light fixtures 106. The transmitter in the light fixture 106a can also transmit signals back to the control unit 102 to provide for bi-directional communication as described above.

This arrangement provides flexibility of powering and controlling the lighting fixtures 106. The power and control signal can be transmitted to the light fixtures along the wire 108, or if necessary or desired, control signals can be wirelessly transmitted between the control unit and the fixtures 106 as described above. If the run of light fixtures 106 in the wire 108 is too long to efficiently transmit power and control signals to the light fixtures 106 on the wire 108, wireless signals can be used to transmit control signals to light fixtures 106 further down the run. The light fixtures 106 can also wirelessly communicate with each other to reach light fixtures out of line of sight with the control unit 102 and its radio 110. This arrangement provides the flexibility of allowing the system or the user to select the best method (wire or wireless) of communicating with the light fixtures 106, depending on the arrangement of the light fixtures 106.

It is understood that the system described above can also comprise below ground light fixtures and the different light fixtures can be arranged for control by signals on the wire 108 or by wireless control. It is also understood that the control unit can be controlled by the user using any of the above-mentioned methods, such as by cell phone or laptop. In also understood that in other embodiments, controller could be upstream from the transformer on the main power lines, and the radio 110 can be arranged in many different locations.

It is understood that many different mechanisms and arrangements can be used in the different systems according to the present invention, and the present invention can be used to control many different fixtures and systems beyond lighting fixtures and systems. This can include, but is not limited to Internet of Things (IOT) devices and systems, and other appliances, building automation devices or systems, door openers, etc. Although the present invention has been described in detail with reference to certain configurations thereof, other versions are possible. Therefore, the spirit and scope of the invention should not be limited to the versions described above.

I claim:

1. A lighting fixture system, comprising:
a first light fixture coupled to and capable of receiving control signal along a first powerline of a first building;
a second light fixture capable of receiving wireless control signals;
a control unit for generating control signals to control emission of said first and second light fixtures, said control unit coupled to said powerline and capable of sending a control signal on said powerline to said first fixture, and wherein said control unit generates wireless control signals and is capable of transmitting said wireless control signal to said second fixture.

2. The system of claim 1, wherein said control unit is controlled by a user at a user interface.

3. The system of claim 1, wherein said first fixture is first fixture is at least partially below ground and said second fixture is above ground.

4. The system of claim 1, wherein said first fixture comprises a wireless transmitter and receiver capable of wireless communication with said second fixture.

5. The systems of claim 1, where said second fixture comprises a wireless transmitter and receiver capable of wireless communication with said first fixture.

6. The system of claim 1, wherein said first fixture is capable of sending a signal to said controller along said powerline.

7. The system of claim 1, wherein said second fixture is capable of sending wireless signals to said control unit.

8. The system of claim 1, comprising a second powerline, wherein said first powerline is electrically coupled to said second powerline and communicating said control signals to said second powerline.

9. The system of claim 8, further comprising a third light fixture coupled to said second powerline and capable of receiving said control signals on said second powerline.

10. A multi-mode control system, comprising:
a control unit;
a plurality of first electric or electronic devices arranged to receive wireless control signals, at least some of said first devices receiving wireless control signals from said control unit, wherein said control unit is capable of generating wireless control signals to control operation of at least some of said first devices; and
a plurality of second electric or electronic devices coupled to and arranged to receive control signals from a first powerline, wherein said control unit is coupled to and transmits control signals along said first power line to control operation of at least some of said second light fixtures.

11. The system of claim 10, wherein said control unit is controlled by a user at a user interface.

12. The system of claim 10, wherein at least one of said plurality of first fixtures comprises a wireless transmitter capable of wireless communication with another of said first fixtures or one of said second light fixtures.

13. The systems of claim 10, wherein at least one of said plurality of second fixtures comprises a wireless transmitter capable of wireless communication with another of said second fixtures or one of said first light fixtures.

14. The system of claim 10, wherein at least one of said second fixtures is capable of sending a signal to said controller along said powerline.

15. The system of claim 10, wherein said second fixture is capable of sending wireless signals to said control unit.

16. The system of claim 10, comprising a second powerline, wherein said first powerline is electrically coupled to said second powerline and communicating said control signals on said second powerline.

17. The system of claim 8, further comprising a third light fixture coupled to said second powerline and capable of receiving said control signals on said second powerline.

18. A lighting fixture control system, comprising:
a wireless device capable of generating control commands and wirelessly transmitting said control commands;
a control unit arranged to receive said control commands and generate wireless fixture control signals and powerline light fixture control signals;
a plurality of first light fixtures wherein at least some of said first light fixtures are arranged to receive said wireless fixture control signals; and
a plurality of second light fixtures coupled to and arranged to receive control signals from a first powerline, wherein said control unit transmits said powerline light fixture control signals on said first powerline.

19. The system of claim 18, wherein said wireless device comprises a cell phone.

20. The system of claim 18, wherein 12, wherein at least some of said first and second light fixtures comprises a wireless transmitter capable of wireless communication with another of said first and second light fixtures.
